(19) United States
(12) Patent Application Publication
(10) Pub. No.: US 2012/0212941 A1
(43) Pub. Date: Aug. 23, 2012

(54) CORDLESS, PORTABLE, RECHARGEABLE FOOD HEATING LAMP

(76) Inventor: JOMAR RESCHREITER, Scottsdale, AZ (US)

(21) Appl. No.: 13/162,509

(22) Filed: Jun. 16, 2011

Related U.S. Application Data
(60) Provisional application No. 61/445,167, filed on Feb. 22, 2011.

(51) Int. Cl. F21L 4/08

(52) U.S. Cl. 362/183

(57) ABSTRACT

A portable, rechargeable heat lamp keeps food warm for hours. The heat lamp has a base with at least one rechargeable battery. The battery has a connection point for recharging and another connection point for an electrical wire to connect to the heating lamp; and ii. a power management system. The heat lamp also has a neck to carry the electrical wire from the battery to the light fixture, the neck being connectable to the base and to the light fixture. The light fixture has a heating light bulb, a cover for the light bulb and a screw holder which hold the light bulb in place and provides an electrical contact for the light bulb.

### RELATED APPLICATIONS

This nonprovisional application claims the benefit of pending U.S. provisional application No. 61/445,167, filed Feb. 22, 2011. The provisional application is hereby incorporated in its entirety.

### TECHNICAL FIELD

The present invention relates to a heater for keeping food warm in catering, the military, and outdoors. More particularly, the present invention relates to a portable, rechargeable food heating lamp that maintains food at safe temperatures.

### BACKGROUND

Current food industry heat lamps require an electrical constant power source, namely connection to a source of alternating current. Electrical cords limit placement of the heat lamp and cause liabilities as workers rush around and trip over the numerous cords. In commercial settings such as restaurants and hotels, prior to food set up, servers arrange the serving table; then electricians place and connect the cords, tape them down and charge in excess of $150 per lamp. This practice is also time-consuming and requires the host to pay for longer time periods for servers and other personnel.

Food often must be served in areas far from electrical outlets, where food is kept warm with fire, which is also a hazard. People would like to serve food near water, such as on cruise ships, near pools, etc. It is hazardous to provide electrical cable and electrical outlets near such sources.

### SUMMARY

In one embodiment, a portable heat lamp keeps food warm. This heat lamp has a base with at least one rechargeable battery with output sufficient to power a heating light bulb, the battery having a connection point for recharging and another connection point for an electrical wire to connect to the heating lamp, and a power management system. The heat lamp also has a neck to carry the electrical wire from the battery to the light fixture, the neck being connectable to the base and to the light fixture. The heat lamp also has a light fixture which includes a heating light bulb, a cover for the light bulb and a screw holder that holds the light bulb in place and provides an electrical contact for the light bulb.

Optionally, the portable heat lamp's rechargeable battery includes lithium NCM cells of Li(NiCoMn)O₂. There can be 63 Li NCM cells. Optionally, the portable heat lamp's rechargeable battery has lithium iron phosphate (LiFePO₄) cells. In one embodiment, there can be 16 lithium (FePO₄) cells. The power management system (PMS) can be designed to optimize the battery output capacity, convert DC battery voltage to AC current for the heat lamp.

In another embodiment, there is a method of heating and keeping food warm when there is no nearby electrical outlet and no flame source. This method has the steps of providing a rechargeable heat lamp; placing the rechargeable heat lamp sufficiently close to food to maintain the food's temperature for the serving period; and after the serving period, recharging the heat lamp.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a front (food-facing side) view of the lamp showing the bulb, cover, neck, base of the lamp that contains the fuel cells.

FIG. 2 is a perspective view of the back of the lamp showing two operating switches and a vent.

FIG. 3 is a see-through view of the base of the lamp showing a 3D image of where the lithium NCM cells reside within the base, as well as the location of the power management system.

FIG. 4 is a cutaway 3D image of the base of the lamp with the rear panel removed. The inside reveals multiple Lithium cells and the power management system.

FIG. 5 is a cutaway view of the base from the top showing the power management system on the right.

FIG. 6 is a side view of the of the lamp base with ventilation holes.

FIG. 7 is a view of the outside of the back of the lamp with the power switches

FIG. 8 shows a seven-segment LED display of the type to be used with the 10 amp base.

### DETAILED DESCRIPTION OF THE PREFERRED EMBODIMENTS

The rechargeable heat lamp solves numerous problems in the food service industry. The inventive heat lamp provides mobility and versatility because it does not have to be connected to a power source when in use. Therefore, it can be used anywhere, without the constraints posed by the requirements of a power outlet and cables. The rechargeable heat lamp can be used in outdoor areas where electricity is not easily available or dependable. Indoors the lack of an electrical cable allows for easy and quick change of food set up due to the fact that no electrical outlets have to be cabled, changed and/or reset.

The rechargeable heat lamp further provides substantial cost savings because it does not require advanced set up by an electrician, in contrast to the cable-operated lamp. The current set-up costs for electrical installation of a cable-operated heat lamp can range from $100 to $150 per lamp per use, depending on location. If the electrician cannot immediately make connections, there may be delays in food set up and service.

In addition, the rechargeable heat lamp improves safety and diminishes liability concerns. The cordless, rechargeable heat lamp eliminates the use of cables in the high-traffic, food serving area. In the food serving area, both servers and customer focus on the food, not their footing, so there is an inherent risk associated with trips and falls due to the cable that our cordless model totally eliminates. Furthermore, the lack of power cords means that the rechargeable heat lamp can be used in areas near water without risk from power cords contacting water. Therefore, the rechargeable heat lamp 10 can be used near swimming pools, in cruise ship settings, outdoor events, military use, and any other areas where electricity is not readily available.

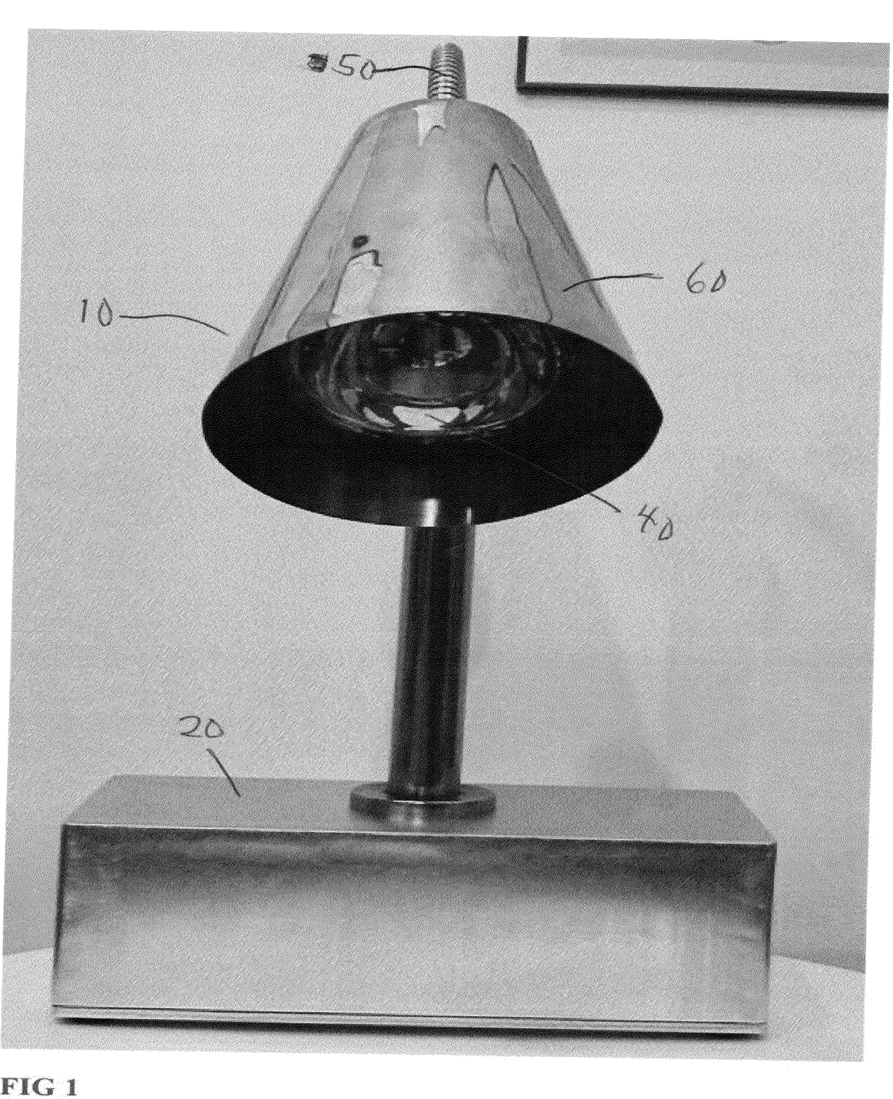

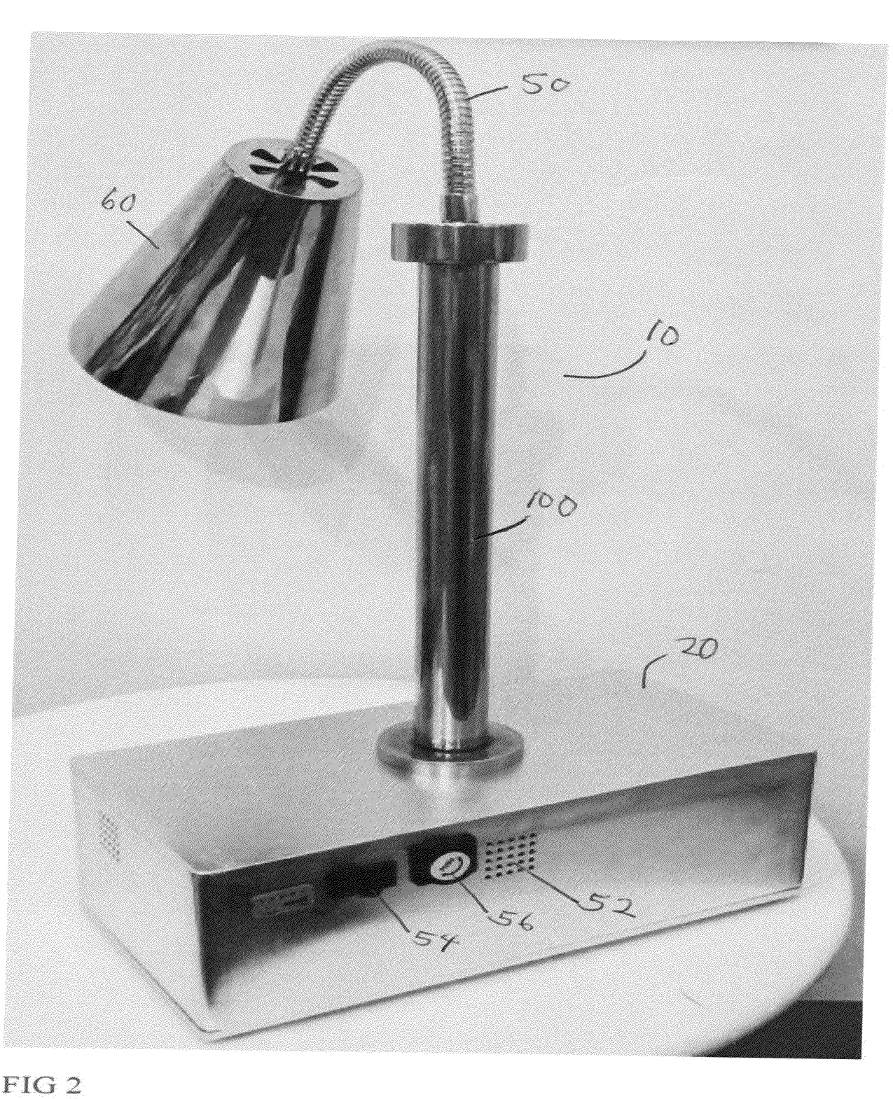

FIG. 1 shows an exemplary rechargeable heat lamp 10 with a base 20 that contains a rechargeable battery(ies) (not shown). The inventive heat lamp 10 has four integral components: the bulb 40 with a flexible neck 50 that is 450 mm long (different from the standard lamps), the base 20 containing the rechargeable battery (not shown), and a power management system in the base (not shown) and an integrated battery charger with DC/AC inverters fully integrated inside the housing (see below). The bulb 40 has a cover 60. FIG. 2 is a rear view of the lamp 10 and neck 50 showing power controls away from the food side and a vent 52 for heat escape from the discharging batteries. Rocker switch 54 is an on-off switch. Dial 56 can be used to adjust the heat output.

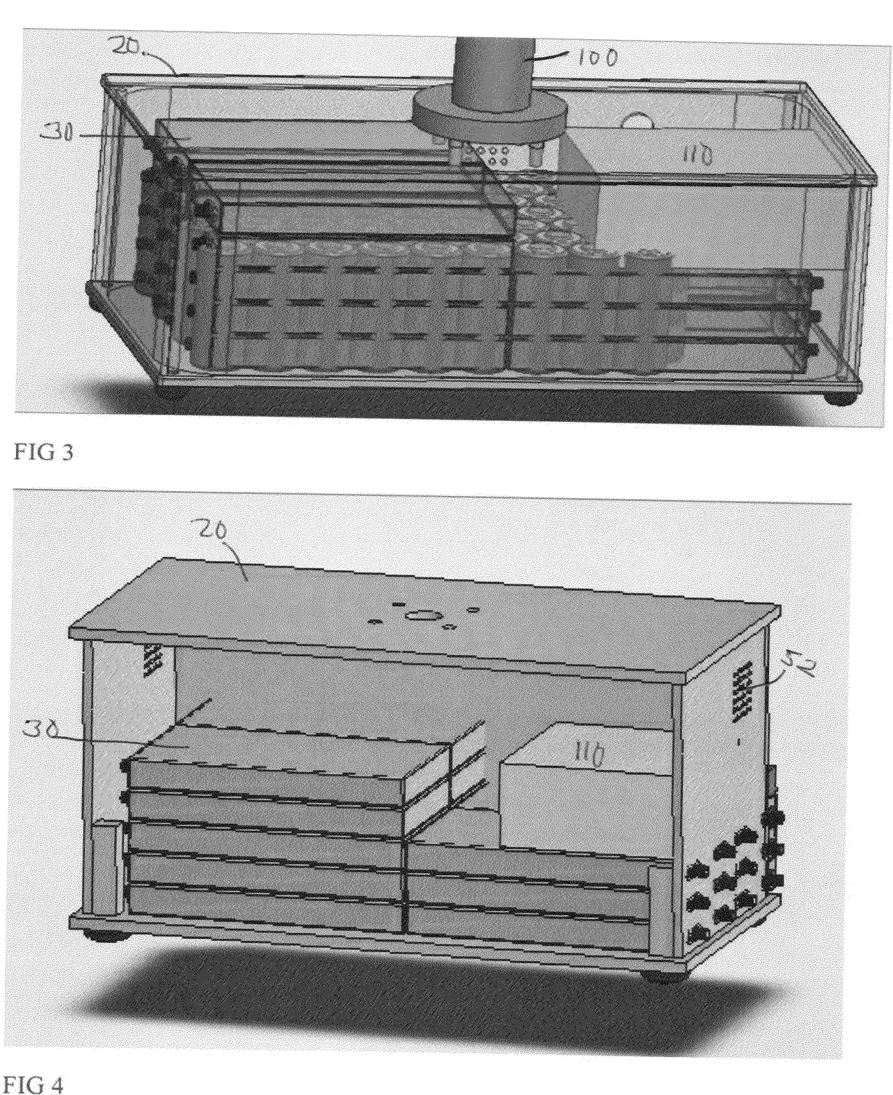

FIG. 3 is a three-dimensional view inside the base 20 on which sits the lamp's metal tube 100. The power management system (PMS) 110 is designed to optimize the battery output capacity over an extended period of time. The PMS 110 converts the DC voltage from the battery to AC current for a typical heat lamp bulb 40. The PMS 110 can be adjusted to provide AC in 110 or 220 volts. The PMS 110 also can provide DC for LED bulbs.

The rechargeable heat lamp 10 can be powered via at least two different battery systems. FIG. 3 shows 63 Lithium NCM [Li(NiCoMn)O₂] cells that together produce 32.4 amps and 24 volts. This particular battery 30 can power the heating lamp 10 for up to three hours. The battery 30 can be recharged up to 800 times before it starts diminishing its recharging capabilities

FIG. 4 shows a different battery 30 set up that includes 16 lithium (LiFePO₄) cells in the battery 30 that together produce 30 amps and 24 volts. This amount of charge will power our inventive heat lamp 10 for about three hours. This battery 30 can be recharged up to 1200 times before it starts losing its recharging capabilities.

Either of these battery systems 30 can be reconfigured to allow for a heating lamp 10 that can be powered for different amounts of times from one hour to up to six hours as needed.

Besides the two described above, the rechargeable battery 30 is of any type capable of producing sufficient power to sustain a heat lamp 10 for about one to six hours, and preferably two to four hours. The number of hours can be adjusted to customer specifications, providing the flexibility to create the lamp 10 with batteries 30 that last from one hour up to six hours. Most rechargeable batteries are self contained. For the invention, it is preferred that the battery be sealed to provide protection against outside elements. More preferred is a laser seal. The battery housing has an outlet for the external battery charger as well as an “on/off” switch. Another version of the lamp includes an integrated battery charger and DC/AC inverter all housed inside the lamp base 20. This system allows for the lamp to be used even if the battery is not charged, where a power outlet is available. This improved version also eliminates the requirement of carrying an external charging unit.

The stem of the lamp can be removed by a simple mechanism for easier handling and shipping. Alternately, the battery 30 set slides into and out of the base, so that one battery 30 set can be recharged while another powers the lamp as it continues to operate.

FIG. 5 shows the inside of the housing base 20. It contains the PMS (Power Management System) 110 that controls and balances the serial connection of the cells and protects against failures like short circuits and power surges. The output of the PMS 110 (24V DC) is connected to a DC/AC inverter, which converts the 24 VDC to 110 AC for the heat lamp.

A preferred battery system is a lithium iron phosphate battery (LiFePO₄) that is 100% recyclable, non-toxic and environmentally benign. Preferably it is enclosed in a water resistant casing. Each individual battery cell is 3.2 volts/15 amps. The battery life cycle is 1200 charges before it starts diminishing its charging capabilities

The alternate, more advanced battery system is a lithium NCM battery 30 composed primarily of Li(NiCoMn)O₂. It is also 100% recyclable, non-toxic and environmentally benign. The battery cells are fully individually enclosed. Each individual battery cell is rated at 3.65 volts/3.6 amps. The battery life cycle is estimated at 800 charges before its charging capabilities diminish.

The charging time after a standard two-hour heat lamp 10 use is about three hours, with an incremental charge time depending on the battery output cycle used. An optional fast charger is also available and reduces the recharging time from a standard of six hours to three hours. In another embodiment, the base permits stacking with additional batteries for extended operating power use of the lamp. Alternative models are capable of charging with solar panels.

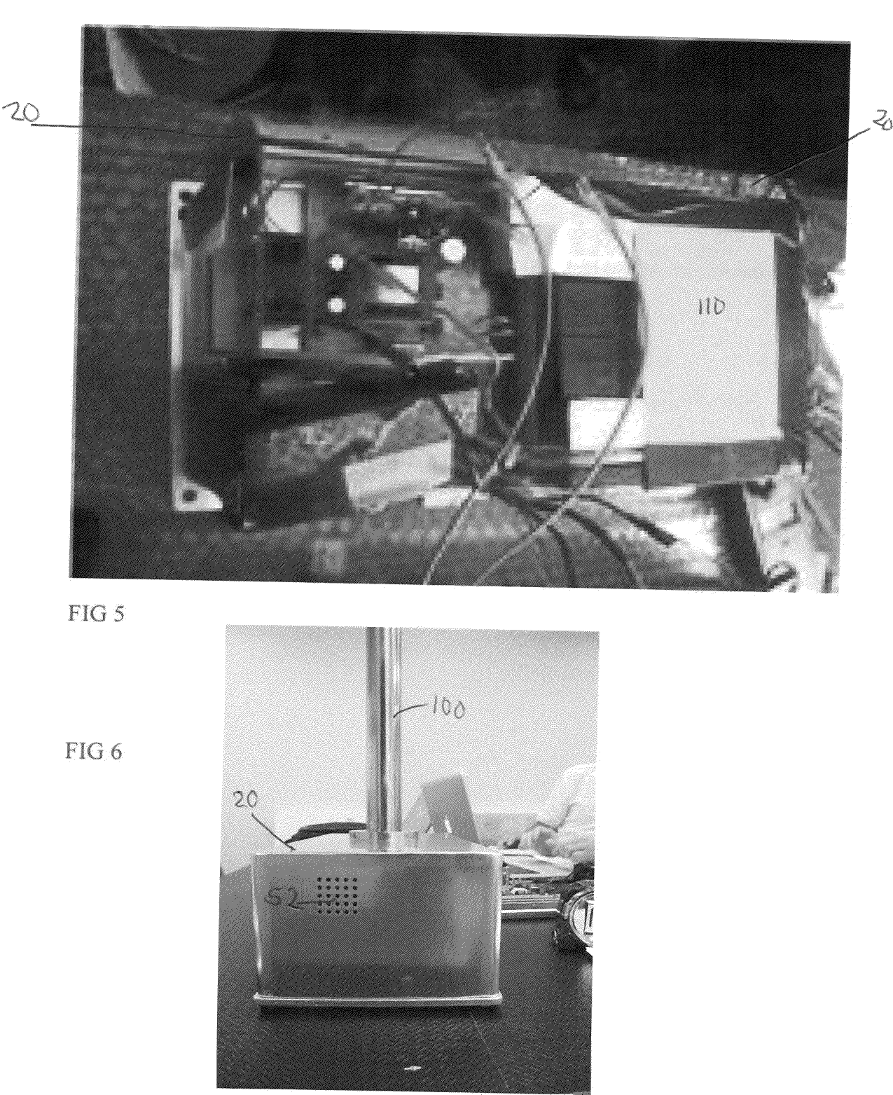

The heat lamp 10 is typically made of an attractive but inexpensive material that stands up to frequent use and withstands the heat of the heat bulb. The material is typically metal that includes but is not limited to stainless, steel, aluminum, brass, copper and amalgams. The lamp has a stem, a flexible arm that may be the stem or a separate component, a lamp cover and a heat-generating lamp. The heat lamp bulb preferably generates heat with an output of 250 watts. The flexible arm can be adjusted to the desired distance required between the heat source and the food. Typical heat output for the lamp ranges from 120 to 180 degrees Fahrenheit. The heat lamp bulb 40 can be an AC bulb. FIG. 6 shows the side of an embodiment of the base 20 of the heat lamp 10. In this embodiment, there are heat vents 52 on the side face.

In some instances, the battery is not removed from the base, but the light portion above the base is removed for easy transport.

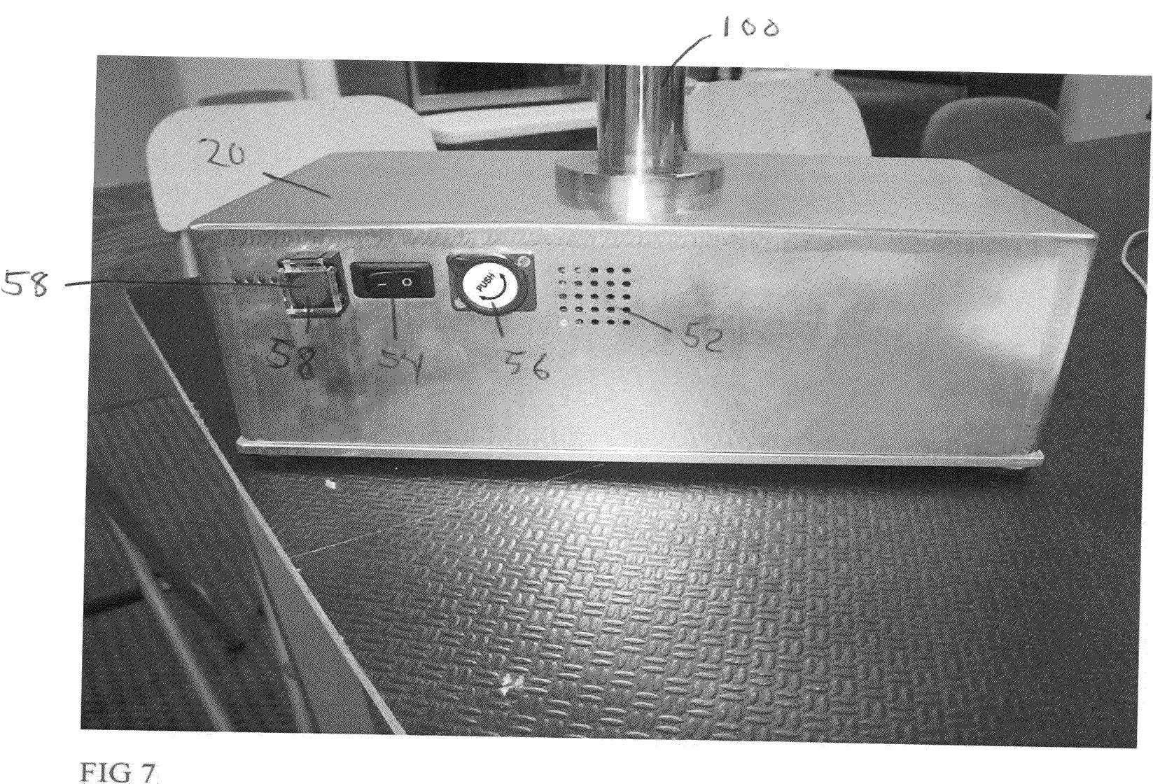

FIG. 7 shows the back powering panels and the lamp tube 100. The power panels consist of two switches. One allows for the battery 30 to conduct power and the other switch will turn on the actual lamp. The pair of switches are a safety feature that eliminates the possibility of accidentally powering on during transportation or other times when the lamp should not be in use. This picture also shows the LED bar indicator 58 that indicates the present amount of charge left in the battery. The powering panel (pair of switches 54 and 56 and LED indicator 58) can be indented into the base housing unit 20 and further covered by a sliding door (not shown), providing added protection and more appealing look.

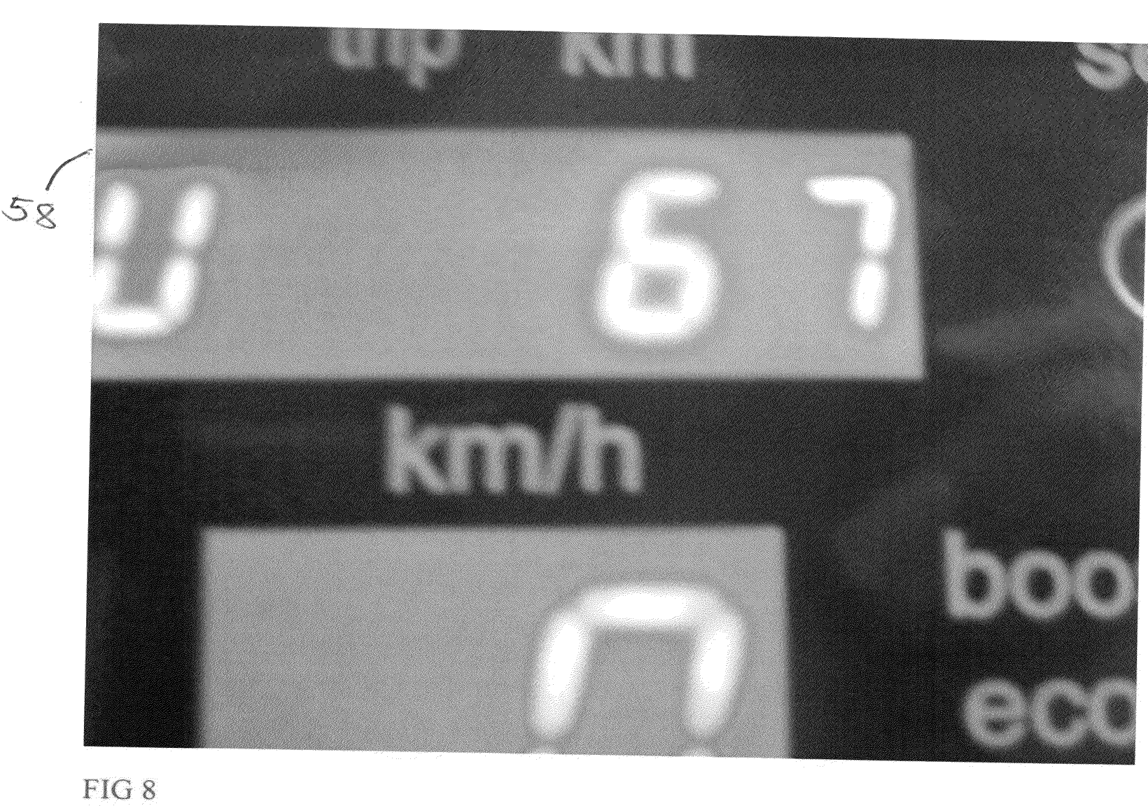

FIG. 8 shows an example of a seven-segment LED display 58 that can be designed to show the amount of battery time (or charge) left from the charge.

The final product that includes the battery, power management system, battery charger with integrated DC/AC inverter and the heat lamp as a single unit, has a manageable weight of 26 pounds or less depending on the battery (combination of fuel cells used), which makes it highly portable and easy to use by any given individual in the food service industry. In one embodiment, the base 20 or battery housing measures 13.5 inches long and 5 inches high. In this embodiment, the total height for the entire product as a single unit is 27.5 inches.

Use of the Portable Battery-Powered Heat Lamp

The invention can be utilized in varying food service applications. Before use, the lamp battery is recharged in an energy source (electrical or solar). The portable heat lamp can then be positioned anywhere—indoors or outdoors—that hot food needs to be maintained at a desired temperature in compliance with food service standard practices. Suitable uses include catering on sites that lack appropriate electrical outlets, including but not limited to patios, pool sides, large open indoor spaces (stadiums, basketball areas, etc.), out in the field during camping or military maneuvers, beachside catering events, or on cruise liners anywhere. In the past I have done catering events in places like the Great Wall of China where I had to run cables all the way from the bottom of the mountain to the Great Wall service area. The same applies to any remote, exotic location where electrical capabilities are limited or restricted. In fact, the more remote or exotic the area, the greater is the need for the inventive lamp.

After use, the battery is recharged. In some embodiments, the battery is removed from the base and taken to a recharging station with electrical power from electrical power supplies, generators or solar sources. In other embodiments, the battery and/or base is detached from the light and support which can be left at the food service area. The battery and/or base is then taken to the recharging location. Once the battery is recharged, it can be reassembled with the rest of the lamp before the food service is set up. This can be done during the night shift or at some other slack time. That schedule reduces delay in food set up.

As can be seen from the drawing figures and from the description, each embodiment and method in accordance with the present invention solves a problem by addressing the need for a rechargeable heat lamp for food service.

Although specific embodiments have been illustrated and described herein, those of ordinary skill in the art will appreciate that any arrangement calculated to achieve same purposes can be substituted for the specific embodiments or exemplary methods shown. This disclosure is intended to cover any and all adaptations or variations of various embodiments of the invention. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the invention includes any other applications in which the above structures and methods are used. Therefore, the scope of various embodiments of the invention should be determined with reference to the appended claims, along with the full range of equivalents to which such claims are entitled.

In the foregoing description, if various features are grouped together in a single embodiment for the purpose of streamlining the disclosure, this method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims, and such other claims as may later be added, are hereby incorporated into the description of the embodiments of the invention, with each claim standing on its own as a separate preferred embodiment.

1. A portable heat lamp for keeping food warm, the heat lamp comprising:
a. a base comprising
i. at least one rechargeable battery with output sufficient to power a heating light bulb, the battery having a connection point for recharging and another connection point for an electrical wire to connect to the heating lamp; and
ii. a power management system;
b. a neck to carry the electrical wire from the battery to the light fixture, the neck being connectable to the base and to the light fixture;
c. a light fixture comprising a heating light bulb, a cover for the light bulb and a screw holder which hold the light bulb in place and provides an electrical contact for the light bulb.

2. The portable heat lamp of claim 1 wherein the rechargeable battery comprises cells of Li(NiCoMn)O₂ (lithium NCM).

3. The portable heat lamp of claim 2 wherein the rechargeable battery comprises 63 Li NCM cells.

4. The portable heat lamp of claim 1 wherein the rechargeable battery comprises lithium iron phosphate (LiFePO₄) cells.

5. The portable heat lamp of claim 2 wherein the rechargeable battery comprises 16 lithium (FePO₄) cells.

6. The power management system (PMS) of claim 1 wherein the PMS is designed to optimize the battery output capacity, convert DC battery voltage to AC current for the heat lamp.

7. A method of heating and keeping food warm when there is no nearby electrical outlet and no flame source, the method comprising the steps of:
a. providing a rechargeable heat lamp;
b. placing the rechargeable heat lamp sufficiently close to food to maintain the food's temperature for a serving period; and
c. after the serving period, recharging the heat lamp.
